(19) United States
(12) Patent Application Publication
(10) Pub. No.: US 2005/0160772 A1
(43) Pub. Date: Jul. 28, 2005

(54) Method for fixing the drum of a washing machine and fitting for the same

(75) Inventor: Ismael Gracia Bobed, Zaragoza (ES)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 11/037,635

(22) Filed: Jan. 18, 2005

(30) Foreign Application Priority Data
Jul. 19, 2002 (ES) P200201803
Jul. 9, 2003 (WO) PCT/EP03/07437

(51) Int. Cl. F16D 51/00; D06F 21/00

(52) U.S. Cl. 68/140; 29/507; 29/522.1

(57) ABSTRACT

The drum (1) is fixed to a mounting star (2), on which a shaft (4) for drive of the drum is fixed. The fixing is achieved by means of arrangement of several openings (6) in the mounting star (2) with different entry and exit diameters, whereby a tip (8) corresponding to each opening (6) is arranged on the drum (1), which is introduced through the smallest hole in the opening (6). The tip (8) is subsequently deformed such that the outer surface thereof is pressed against at least the walls (7) of the opening (6), whereupon the fixing is generated.

### OBJECT OF THE INVENTION

The invention relates to a method for fixing the rear wall of a drum of a washing machine on a mounting star, on which the drum is swivel-mounted via an axis and fixing, which is achieved by means of the method. The object of the invention is to provide fixing with features which enable greater loads to be endured when the drum is rotating, especially in washing machines which tumble at high speeds.

### GENERAL PRIOR ART

It is known that drums of washing machines with rotation capacity are arranged in the interior of a container, for which purpose they are attached on a mounting (known as mounting star), which is connected to a rotating axis, powered by a suitable motor. The mounting star is star shaped, and its mounting arms are fixed on the drum. A known embodiment for fixing the mounting arms on the drum provides screwing the ends of the mounting arms on a peripheral projection, formed on the rear wall of the drum.

In the past the decision has been made to rivet the end of each mounting arm of the mounting star on the rear wall of the drum itself instead of the screw connections on the peripheral projection and by means of a metallic reinforcing plate, by means of which the bond for mounting the drum is made.

### DESCRIPTION OF THE INVENTION

These known methods of fixing have disadvantages. In the first case the loads, which occur when the drum rotates at high speeds, are absorbed by the points, at which the connection of the end of the mounting arms is made with the peripheral projection of the drum. This can, especially with high-speed tumbling, cause tearing in the drum, or the mounting points cannot withstand the loads at high speeds.

In the second case the necessary metallic reinforcing plates are cause for high costs of the fixing method. Also, there is only fixing for each of the mounting arms of the mounting star, whereby the mounting points for drums rotating at high tumbling speeds are not solid enough despite the strengthening by the reinforcing plate.

In order to eliminate the abovementioned disadvantages the object of the invention is to develop a novel fixing method for the drum of a washing machine, in which the mounting star for the rotating axis and its fixing are less expensive but still more stable.

The method according to the invention solves this task in that the rear wall of the drum on the mounting star is attached at several openings of the mounting star with entry and exit diameters of differing size, in that for each opening a tip is drawn through the entry with the smaller diameter from the sheet of the rear wall of the drum in the assigned opening, in that then the tip is widened out against the walls of the opening, which establish the major difference between the entry and exit diameters of the opening.

The inventive method provides that deformation of the already drawn tip is made by use of a press tool, in that the press tool with a complementary surface matching the truncated surface of the late tip form is guided through the larger hole and the upper part of the tip and presses against the inside of the tip, resulting in its final form.

The method of the invention can be applied to any configuration of the mounting star. But since the latter conventionally has a star shape, the inventive method provides that there is at least one opening for a tip provided in the drum rear wall in each mounting arm of the star.

In an embodiment of the invention the walls of the opening, against which the corresponding tip of the drum presses, have a surface which widens in the direction of the upper end of the tip, such that when the tip deforms the latter opens in the direction of said surface and presses against the surface. This produces the fixing between the mounting star and the drum.

Widening of the walls of the opening, against which the tip presses, can take on any configuration. In the preferred embodiment it has a truncated shape, preferably in its entirety determined by the tip.

There is also the possibility that the walls of the opening, which determine the major difference between the entry and exit diameters and against which the respective tip of the drum presses, contain at least one graduation, to which the tip adapts when deforming and pressing.

A further embodiment contains in the truncated area of the opening several graduations for fixing the drum even more securely.

Obviously, in each mounting arm of the mounting star a sufficiently large number of holes can be made, as is adapted to the demands made on the drum depending on the desired tumbling speed, and in this way fixing takes place at different sites on the mounting arms.

In addition, the method according to the invention offers the possibility, to add at least one lateral widening at least in an area of the mounting arms, in which at least one opening is made, in which a corresponding tip of the drum is held. Where the mounting star is configured as a star-shaped component at least one lateral widening is arranged at the lateral ends of each mounting arm.

The inventive method can provide that the tip of the drum is designed by means of a press-in process.

The fixing obtained by means of the method of the invention is characterised in that the mounting star has several openings with various entry and exit diameters, in which in each case one tip is inserted from the smaller entry diameter, which is drawn from the rear wall of the drum, such that the tip presses at least against that area of the walls of the opening, which determine the differences between the entry and exit diameters.

The walls of the opening of the mounting star, with which the fixing is executed, as well as the mounting star itself and the drum exhibit those features which have already been described in the method according to the invention.

Hereinbelow a series of figures is attached, in which the object of the invention is explained and illustrated in a non-limiting way for better comprehension of the description and as part thereof.

### BRIEF DESCRIPTION OF THE FIGURES

FIG. 1 is a perspective partial view of the interior of the drum, on the rear of which the tips are recognisable, which are designed by pressing in for fixing of the mounting star and which are located on the outside of the drum,

FIG. 2 is a perspective partial view of the outside of the drum and of one of the mounting arms of the mounting star, on which it is fixed, whereby a detail of the opening is also to be seen, which is placed in the mounting star for configuring the fixing of the tip of the drum,

FIGS. 3a to 3d are a schematic illustration of the different sequences provided by the inventive method for carrying out the fixing of the mounting star with the drum,

FIG. 4 is a perspective partial view of another embodiment of the ends of the mounting arms, in each of which a lateral widening is started, which is fixed by means of the inventive method on the drum, and this figure also shows the fixing of the end of the mounting arm, in which the fixing is strengthened by means of conventional riveting and a metal plate, and

FIG. 5 shows a detail from the example of FIG. 4, in which the fixing is strengthened by conventional means and by a metal plate.

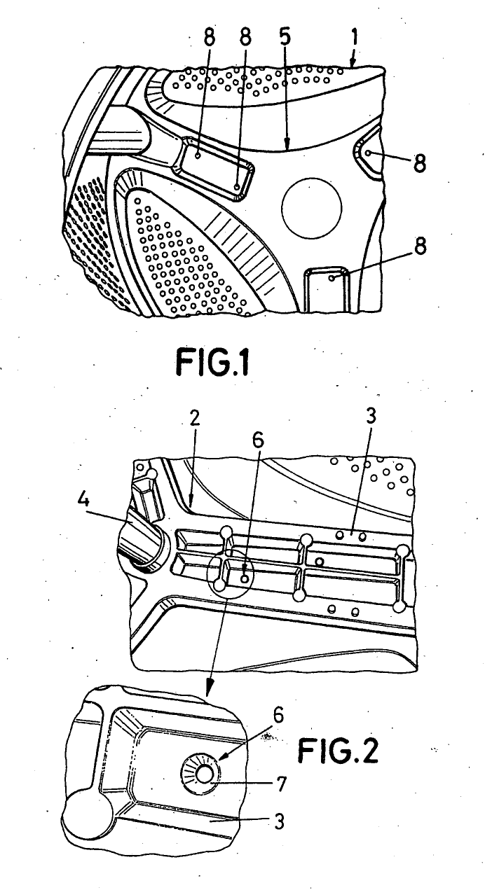

### DESCRIPTION OF A PREFERRED EMBODIMENT

A drum 1 and a mounting star 2 are partially illustrated in the figures. Because these are well-known elements, a complete illustration of all these elements was omitted.

The drum 1 is fixed on the outside of its rear wall on the mounting arms 3 of the mounting star 2, which is configured star shaped.

The mounting star 2 for its part is connected solidly to a shaft 4, which is connected to a drive motor (not illustrated here) to generate the rotation of the drum 1 in a lye container, not illustrated.

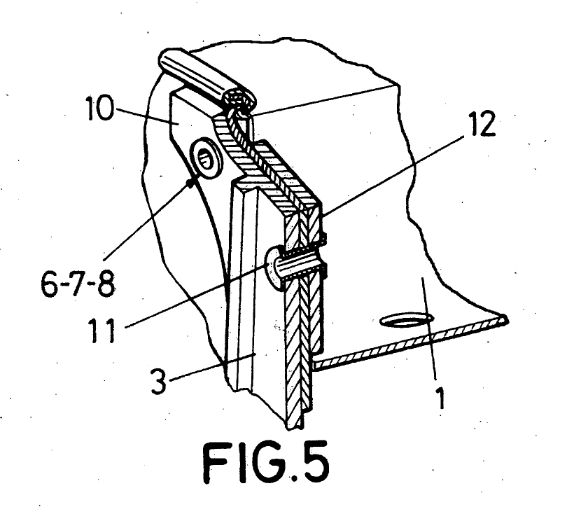

The rear wall of the drum 1 is fitted with grooving 5 in a star shape, in which the mounting arms 3 of the mounting star 2 are situated. One of the fixings, which are conventionally used to connect the ends of the mounting arms 3 of the mounting star 2 to the drum 1, comprise attaching a rivet 11 (FIGS. 4 and 5) by means of interposing a metal plate 12, which reinforces the connection, as insufficiently described above by way of the prior art as for washing machines, which tumble at a very high speed. For this reason the invention proposes an alternative or complementary fixing to the fixing produced by conventional means, for which reason at least one opening 6 with truncated side walls is designed in each mounting arm 3 of the mounting star 2, which determine an entry of greater diameter than the exit.

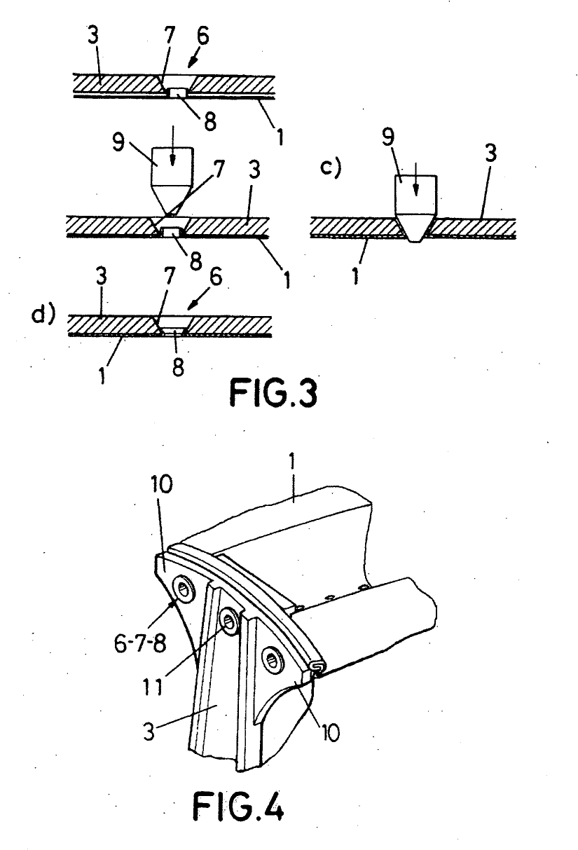

In the embodiment two openings are made for in each case one of the mounting arms, but there is the possibility of arranging one opening or more as two, depending on the loading of the drum caused by the tumbling speed. Arranged on the rear wall of the drum 1 and the number of openings 6 are one or more tips 8, which project outwards, so that each tip 8 can be housed in the opening 6, as in FIG. 3a. The tip 8 can be created by pressing or drawing from the inside of the rear wall of the drum 1.

When the tip 8 is introduced into the opening 6, a drift punch 9 is guided through the outside (greater diameter) of the opening 6, whereby the drift punch 9 a truncated mantle surface has, which corresponds to the truncated surface 7 of the opening 6. When the drift punch 9 lowers its lower end enters the tip 8, so that the tip 8 widens until it presses against the truncated walls 7 of the opening 6 (FIG. 3c), so that when the drift punch 9 is removed (FIG. 3d) the fixing of the drum 1 on the mounting star 2 is completed. In this way fixing with several mounting points is achieved, which share the load, thus guaranteeing greater resistance.

The truncated wall 7 can contain a graduation (not shown in the figures). In this case the drift punch 9 must contain a corresponding graduation, to be able to exert the correct and as far as possible whole-surface pressure with respect to the tip 8 on the walls of the opening.

The invention also provides that, if wanted, for greater loads respective widening 10 can be provided at the ends of the mounting arms 3 of the mounting star, in which there is at least one opening 6, to execute the fixing according to the invention, whereby also a conventional connection can be provided by means of the abovementioned rivet 11.

1-13. (canceled)

14. A method for fixing the rear wall of a drum of a washing machine on a mounting star, on which the drum is swivel-mounted via an axis, the method comprising:
the rear wall of the drum is fixed on the mounting star at several openings of the mounting star with entry and exit diameters of differing size,
in that for each opening a tip is drawn through the entry with the smaller diameter from the sheet of the rear wall of the drum in the assigned opening,
in that then the tip is widened out against the walls of the opening, which determine the major difference between the entry and exit diameters of the opening.

15. The method as claimed in claim 14, wherein said deforming of the already drawn tip is caused by use of a press tool, in that the press tool with a complementary surface matching the truncated surface of the later tip form is guided through the larger hole and the upper part of the tip and presses against the inside of the tip, thereby creating its final form.

16. The method as claimed in claim 14, wherein the walls of the opening have at least a combination with a truncated surface and at least a graduation and the complementary surface of the press tool forms the parts of the combination.

17. The method as claimed in claim 14, wherein the mounting star has a star-shaped configuration, in the mounting arms of which in each case at least one opening is provided, in which the corresponding tip of the drum is drawn.

18. The method as claimed in claim 14, wherein the tip of the drum is made by a press-in process.

19. A fixing for connecting a drum having a rear wall and a washing machine having a mounting star, on which the drum is swivel-mounted via an axis, the fixing comprising:
the mounting star including at least one opening having walls and entry and exit diameters of differing size;
the rear wall of the drum being fixed on the mounting star at the at least one opening;
at least one tip projecting outwardly from the rear wall and extending through the entry diameter of the at least one opening; and
the tip being widened out against the walls of the opening, which determine the major difference between the entry and exit diameters of the opening.

20. The fixing as claimed in claim 19, wherein at least one opening for a tip of the rear wall of the drum is arranged in the lateral widening.

21. The fixing as claimed in claim 19, wherein the mounting star has several openings with various entry and exit diameters, in which in each case a tip is introduced from the smaller entry diameter, which is then drawn out of the rear wall of the drum such that the tip presses against at least that area of the walls of the opening, which determine the differences between the entry and exit diameters.

22. The fixing as claimed in claim 21, wherein the walls of the opening, against which a corresponding tip presses, have a surface which widens at least partially in the direction of the upper end of the tip.

23. The fixing as claimed in claim 22, wherein the widening of the walls of the opening has a truncated form.

24. The fixing as claimed in claim 22, wherein the walls of the opening, which determine the various entry and exit diameters, contain at least one graduation to which the tip is adapted positively.

25. The fixing as claimed in claims 22, wherein the walls of the opening comprise at least a combination of a truncated surface and at least one graduation.

26. The fixing of a washing machine drum as claimed in claim 19, wherein the mounting star has a star-shaped configuration, which contains in its mounting arms in each case at least one opening.

27. A method for mounting a drum on a mounting star of a washing machine, the method comprising the following acts:
providing at least one opening extending through the mounting star, the opening having a truncated internal surface defining a larger end and a smaller end, in which the cross-sectional area of the larger end is greater than the cross-sectional area of the smaller end
providing at least one tip extending outwardly from the drum wherein an end of the tip opposite the drum at least partially defines a cavity;
aligning the tip of the drum with the opening of the mounting star;
inserting the tip into the smaller end of the opening such that the tip is at least partially disposed within the opening; and
widening the tip outwardly toward the truncated surface of the opening to couple the drum to the mounting star.

28. The method as claimed in claim 27, wherein the act of widening the tip further comprises the act of inserting a press tool into the larger end of the opening to press the tip against the truncated surface of the opening.

29. The method as claimed in claim 28, wherein the press tool has a truncated external surface substantially corresponding to the truncated surface of the opening.

30. The method as claimed in claim 27, wherein the mounting star includes a star-shaped configuration having multiple arms extending radially outwardly from a shaft and each arm includes at least one opening, and the drum includes a tip corresponding to at least opening on each arm, the act of aligning the tip of the drum with the opening of the mounting star further comprising aligning each tip on the drum with the corresponding opening on the arms of the mounting star.

31. The method as claimed in claim 27, wherein the act of providing at least one tip further comprises making the tip of the drum with a press-in process.

32. A washing machine comprising:
a housing;
a mounting fixture supported within the housing for rotation, the mounting fixture having at least one opening extending through the mounting fixture, the opening having a larger end and a smaller end, in which the cross-sectional area of the larger end is greater than the cross-sectional area of the smaller end; and
a drum connected to the mounting fixture and having at least one tip extending outwardly from the drum and having an end disposed opposite the drum, the tip extending at least partially into the opening through the smaller end and the end of the tip extending radially outwardly beyond the smaller end.

33. The washing machine as claimed in claim 32, wherein the opening has a truncated shape defining a truncated inner surface, and the tip has a corresponding truncated shape defining a truncated external surface engaging the truncated inner surface and resisting the tip from exiting the opening.

34. The washing machine as claimed in claim 32, wherein the mounting fixture includes a mounting star having multiple arms extending radially outwardly from a shaft and each arm include having at least one opening, each opening having a smaller end and a larger end, the drum including multiple tips extending outwardly from the drum, one of the tips extending at least partially into a corresponding opening on each arm through the smaller end and extending radially outwardly beyond the smaller end of the corresponding opening.
